(19) United States
(12) Patent Application Publication
(10) Pub. No.: US 2026/0303576 A1
(43) Pub. Date: Oct. 1, 2026

(54) SERVICE-BASED TRAFFIC SPLIT ON SECURE TUNNEL

(71) Applicant: Fortinet, Inc., Sunnyvale, CA (US)

(72) Inventors: Jianxiang Chen, Sunnyvale, CA (US); Kun Yu, San Jose, CA (US); Yanheng Wei, San Jose, CA (US)

(73) Assignee: Fortinet, Inc., Sunnyvale, CA (US)

(21) Appl. No.: 19/096,534

(22) Filed: Mar. 31, 2025

(51) Int. Cl. H04L 9/40

(52) U.S. Cl. CPC H04L 63/029; H04L 63/0272

(57) ABSTRACT

Responsive to enabling the split traffic mode, a software-based switch is configured to split layer-2 data traffic between an aggregation link communicatively coupled to the WAN over the secure tunnel and layer 3 NAT communicatively coupled directly to the WAN. Responsive to a service type classification of data traffic matching at least one of the one or more split service types, the secure tunnel is bypassed for the session with the remote destination by switching to the layer 3 NAT for direct transmission to the WAN. Responsive to the service type classification not matching at least one of the one or more split service types, default mode is continued by switching to the aggregation link for transmission to the WAN through the remote firewall.

### FIELD OF THE INVENTION

The invention relates generally to computers and computer network security, and more specifically, for selectively splitting data traffic for exclusion from secure tunneling based on service types.

### BACKGROUND

Network security techniques are essential for protecting clients from a myriad of threats, such as malicious files distributed through Internet. For example, enterprise networks are typically partitioned from Internet and other wide area networks (WANs) by a firewall. Using virtual private networking (VPN), however, employees are able to have access behind the firewall while maintaining security.

However, all data traffic from the employee is forwarded to the firewall, whether it relates to the entity or not. For example, video game traffic between an Internet server and the home network is first encrypted and sent over VPN to the enterprise network before being encrypted, inspected by the firewall and then finally transmitted to the Internet. In turn, response data packets are sent back to the firewall for inspection and then through VPN before reaching the home network. This process is inefficient, putting unnecessary burden on the tunneling process and the firewall in addition to hardware usage. The video game may slow down due to additional flight time. Furthermore, there may be privacy concerns with an entity being privy to personal data traffic.

Therefore, what is needed is a robust technique for selectively splitting data traffic for exclusion from secure tunneling that extends a remote firewall for data traffic destinated to the WAN from the LAN.

### SUMMARY

To meet the above-described needs, methods, computer program products, and systems for selectively splitting data traffic for exclusion from secure tunneling that extends a remote firewall for data traffic destinated to the WAN from the LAN.

In one embodiment, a virtual extendable LAN (VXLAN) over a secure tunnel is established from the network edge device or LAN extender device to a remote LAN firewall. At some point in time, a split traffic mode is enabled in the network edge device. A default mode of the network edge device is configured to transmit WAN data traffic over a secure tunnel for traversing the remote firewall en route to the WAN. A selection of one or more types of service to be split from WAN data traffic headed to the secure tunnel for direct transmission over the WAN without traversing the remote firewall is received.

In another embodiment, responsive to enabling the split traffic mode, a software-based switch is configured to split layer data traffic between an aggregation link communicatively coupled to the WAN over the secure tunnel and a layer 3 network address transaction (NAT) or local LAN bridge interface communicatively coupled directly to the WAN.

In still another embodiment, a session of data packets directed to the WAN from a client is received. A service type associated with the session is identified. Responsive to the service type classification matching at least one of the one or more split service types, the secure tunnel is bypassed for the session with the remote destination by switching to the layer 3 switch for direct transmission to the WAN. Responsive to the service type classification not matching at least one of the one or more split service types, default mode is continued by switching to the aggregation link for transmission to the WAN through the remote firewall.

Advantageously, network performance and computer device performance are improved with better network security.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating aspects of a system for selectively splitting data traffic for exclusion from secure tunneling that extends a remote firewall for data traffic destinated to the WAN from the LAN, according to some embodiments.

FIG. 2 is a more detailed block diagram illustrating a LAN extender device of the system of FIG. 1, according to an embodiment.

FIG. 3 is a sequence diagram illustrating interactions between components of the system of FIG. 1, according to an embodiment.

FIG. 4 is a high-level flow diagram illustrating a method for LAN extension processing of WAN data traffic, according to an embodiment.

FIG. 5 is a more detailed flow diagram illustrating a step for selectively splitting data traffic for exclusion from secure tunneling that extends a remote firewall for data traffic destinated to the WAN from the threats, from the method of FIG. 4, according to an embodiment.

FIG. 6 is a block diagram illustrating an example computing device for the system of FIG. 1, according to an embodiment.

### DETAILED DESCRIPTION

Methods, computer program products, and systems for selectively splitting data traffic for exclusion from secure tunneling that extends a remote firewall for data traffic destinated to the WAN from the LAN. The following disclosure is limited only for the purpose of conciseness, as one of ordinary skill in the art will recognize additional embodiments given the ones described herein.

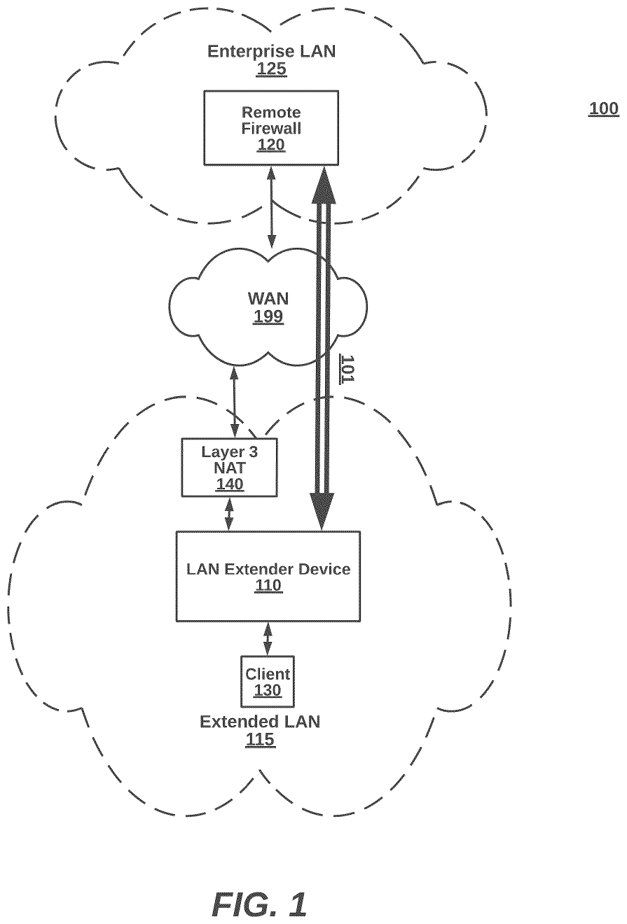

### I. Systems for Extended Firewall Exclusion (FIGS. 1-3)

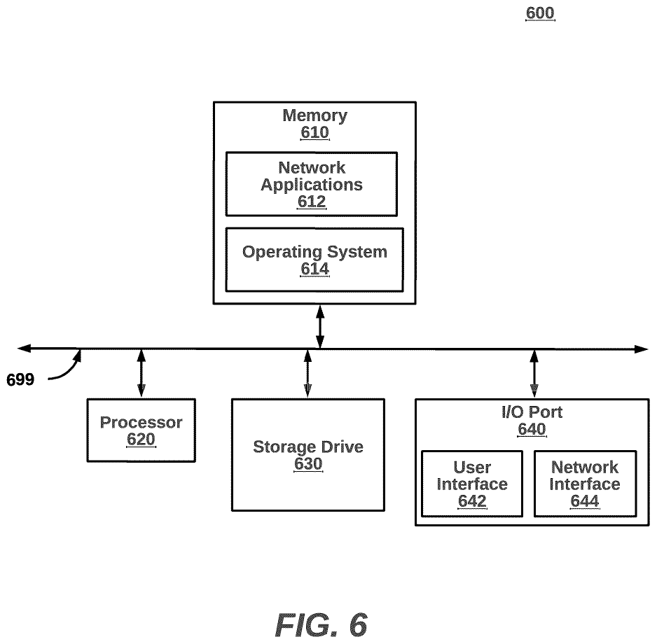

FIG. 1 is a high-level block diagram illustrating a system 100 for selectively splitting data traffic for exclusion from secure tunneling that extends a remote firewall for data traffic destinated to the WAN from the LAN, according to an embodiment. The system 100 includes a LAN extender device 110, a remote firewall 120 and a client, communicatively coupled to the data communication network 199. Other embodiments of the system 100 can include additional components that are not shown in FIG. 1, such as additional extender devices, clients and firewalls, along with servers, gateways access points, Wi-Fi controllers, routers, switches and the like. The components of system 100 can be implemented in hardware, software, or a combination of both. An example implementation of processor-based hardware components is shown in FIG. 6.

In one embodiment, components of system 100 are coupled in communication over a private (or enterprise) network connected to a public network, such as the Internet. In another embodiment, system 100 is an isolated, private network, or alternatively, a set of geographically dispersed LANs. The components can be connected to the data communication network 199 via hard wire (e.g., LAN extender device 110, remote firewall 120 and client 130). The components can also be connected via wireless networking (e.g., client 130). The data communication network 199 can be composed of any combination of hybrid networks, such as an SD-WAN, an SDN (Software Defined Network), WAN, a LAN, a WLAN, a Wi-Fi network, a cellular network (e.g., 3G, 4G, 5G or 6G), or a hybrid of different types of networks. Various data protocols can dictate format for the data packets. For example, Wi-Fi data packets can be formatted according to IEEE 802.11, IEEE 802,11r, 802.11be, Wi-Fi 6, Wi-Fi 6E, Wi-Fi 7 and the like. Components can use IPv4 or Ipv6 address spaces.

In one embodiment, LAN extender device 110 can have multiple Ethernet and/or Wi-Fi input ports connected to downstream clients including client 120. Received local LAN traffic destined to the WAN is selectively split between remote firewall 120 and local direct access. One embodiment includes one or more output ports for the secure tunnel 101 and one or more separate output ports for the excluded traffic. In the current example, excluded traffic is sent to a layer 3 NAT 140 for WAN routing. In a default mode, the LAN extender device 110 extends a remote LAN to a new location by securely tunneling behind remote firewall 120. For example, an employee needing access to company documents on an enterprise network that is not available to the public, can use a VPN tunnel to reach company servers. To the company servers, the employee appears the same as employees that are residing locally and directly connected to the enterprise network. In split traffic mode, the LAN extender device 110 can exclude traffic of certain types. For example, a child playing video games has no need to virtually do so from within the enterprise network, and thus, related data traffic can be excluded from VPN tunneling.

Another type of traffic has destinations that are not part of the WAN. Namely, remote LAN destinated traffic and local LAN destined traffic. The remote LAN destined traffic is not excluded because it is regulated by remote firewall 120. An employee fills out a time card on a local server, for instance. The local LAN traffic is excluded because local devices are not regulated by remote firewall 120. However, in one case LAN extender device 110 creates a virtual office at a satellite office location for several employees, functioning more like a secure bridge between offices. Several employees and servers can be connected to the local LAN, and should be subject to remote firewall 120. In this case, data traffic internal to the local LAN is sent out to remote firewall 120 for inspection before being returned to the local LAN destination.

The LAN extender device 110 can be of a small form factor to be carried around and quickly set up at home or a hotel when out of the office, for example. In one case, a USB or Ethernet wired connection tethers a laptop. In another case, a Wi-Fi or Bluetooth channel wirelessly tethers a smartphone. The LAN extender device 110 may be directly plugged into ports of an upstream layer 3 NAT 140 or router, or wirelessly connected to an access point or home router in a mesh network configuration. The internal software can be plug-and-play in order to automatically find remote firewall 120 and establish a secure tunnel 101 once authorized with a local network gateway. The LAN extender device 110 can be an independent device, or in other examples, integrated to a home router or other edge device.

The remote firewall 120 ensures uniform policies are applied to traffic of an enterprise network. Typically, the enterprise network includes sensitive company data that is not freely accessible from the Internet or other WANs. An employee is authenticated by a specific device or log-in credentials. The remote firewall 120 can be configured to restrict access to WANs in certain ways, such as preventing and/or limiting pornography web sites, social media web sites, and high bandwidth applications that are unrelated to the essential priorities of an entity. Certain employees can have higher privileges relative to default privileges, such as an executive or a network administrator having deeper access, more bandwidth allocation, and less restrictions to WAN traffic. Guests may be quarantined to a separate SSID with very limited capabilities. As a result, a user of a LAN extender device 110 has network activities managed as if accessing the enterprise network directly from on-site. However, certain firewall policies may apply only to those accessing the enterprise network via secure tunnel 101, due to vulnerabilities of secure tunneling.

In some embodiments, the secure tunnel 101 connects to a network gateway device that also executes remote firewall 120. The network gateway or remote firewall 120 can include a module that configures one or more LAN extenders to enterprise LAN 125, and manages real-time secure tunnel connections. A network administrator can register devices and authentication parameters. In one case, 10 or 100 LAN extender devices can have separate secure tunnels active at the same time.

The client 130 can be a laptop computer, a personal computer, a smartphone, or the like. In one case, the laptop computer is company issued and will be recognized and automatically authenticated by the LAN extender device 110 and remote authentication systems, for easier set up. In other cases, a secure tunneling application is downloaded from a server and installed on a local memory. Once invoked by an operating system, the application connects to the LAN extender device 110 and configures the secure tunnel 101.

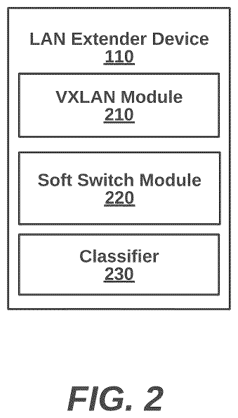

FIG. 2 is a more detailed view of the LAN extender device 110 of FIG. 1, according to an embodiment. The LAN extender device 110 further includes a VXLAN module 210, a soft switch module 220 and a classifier 230. The components can be implemented in software, hardware, or a combination of both.

The VXLAN module 210 establishing a VXLAN over a secure tunnel from the network edge device to a remote LAN firewall. Generally, VXLAN is a network virtualization technology that uses a VLAN-like encapsulation technique to encapsulate layer 2 Ethernet frames within layer 4 UDP datagrams. Different protocols are available for ensuring security to prevent outside access to content being sent over tunnels. VPN can implement IPSec or some other encryption scheme.

The soft switch module 220 enables a split traffic mode in the network edge device by applying a split traffic policy. One or more types of services in the split traffic policy are excluded from the tunnel. For example, UDP, TCP, specific port numbers, specific IP addresses, and specific FQDN names can be split off. Additionally, split traffic policy can be configured to exclude specific applications, specific devices, specific users, or specific time periods. For instance, secure tunneling can be temporarily paused without tearing down the VPN connection. Further, all data traffic from an Xbox console or from a Wi-Fi guest can be excluded. One policy excludes traffic from all users except devices logged into by the employee. A default mode of the network edge device is configured to transmit WAN data traffic to an aggregation link for transmission over a secure tunnel for traversing the remote firewall en route to the WAN. When excluded service types are identified, a software switch in the soft switch module 220 sends the traffic to a layer 3 NAT for direct transmission over the WAN without traversing the remote firewall. The software switch is easily programmed and updated. In one embodiment, a local firewall programs the software switch for excluded data traffic after receiving preferences from a user through a user interface. In another embodiment, remote firewall 120 programs the software switch with data traffic that is not allowed for local exclusion, thereby overriding corresponding local policy.

The classifier 230, receives data packets from sessions, at an input port, directed to the WAN from a client. By checking headers, parsing the data packets, or even by deep packet inspection, service types can be identified. In one case, specific applications are identified from protocols used within a data packet or across several data packets, and exclusion policies can be applied on an application level in addition to a service level. In one embodiment, the classifier 230 ignores traffic addressed internally to the remote LAN.

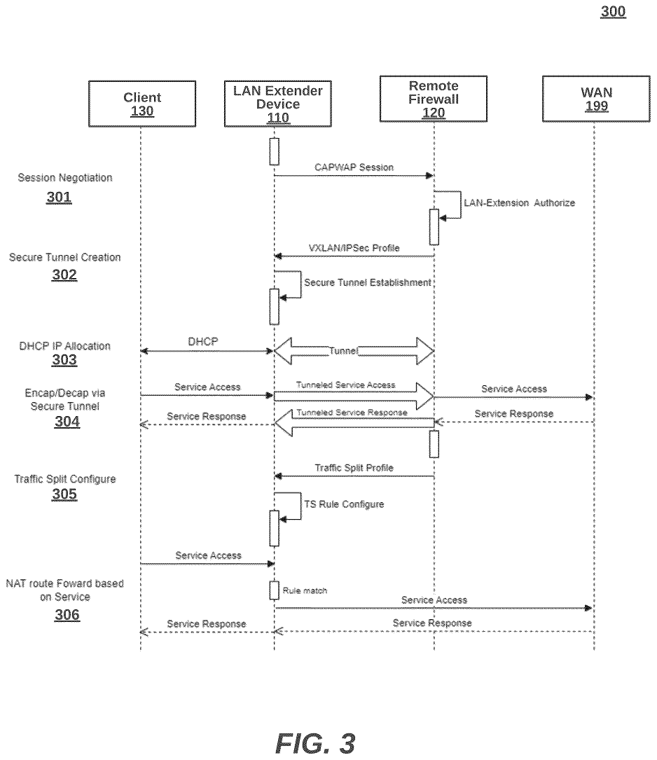

One example of components in system 100 is shown in the sequence diagram of FIG. 3. A session negotiation 301 between LAN extender device 110 and remote firewall 120 sets up a CAPWAP session. A LAN extender session is authorized by remote firewall 120 resulting in a VXLAN/IPSec profile been sent for secure tunnel creation 302. Next, DHCP IP allocation 303 establishes client 130 for communications. A first client 130 communication includes encapsulation/decapsulation of packets via secure tunnel 304 before transmission to WAN 199. Once traffic split is configured 305 and a rule match occurs, a second client communication 130 directly to WAN 199 with NAT route forward based on service 306 being excluded.

There are numerous variations to those that are listed herein, that would be apparent to one of ordinary skill in the art, given the disclosure herein.

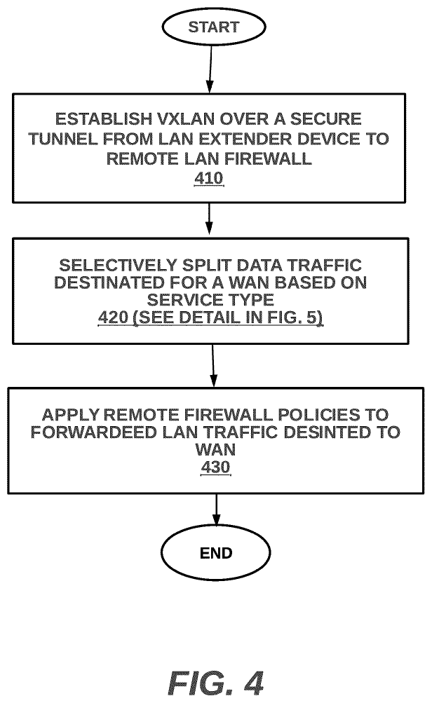

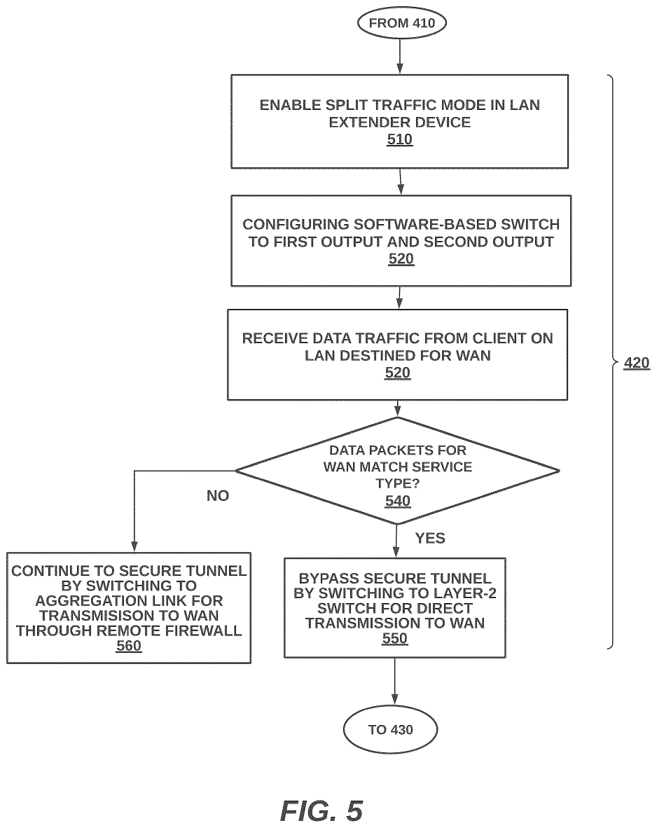

### II. Methods for Extended Firewall Exclusion (FIGS. 4-5)

FIG. 4 is a high-level flow diagram illustrating a method 400 for selectively splitting data traffic for exclusion from secure tunneling that extends a remote firewall for data traffic destinated to the WAN from the LAN, according to an embodiment. The method 400 can be implemented by, for example, system 100 of FIG. 1. The specific grouping of functionalities and order of steps are a mere example as many other variations of method 400 are possible, within the spirit of the present disclosure. Other variations are possible for different implementations.

At step 410, a VXLAN is established over a secure tunnel from the network edge device to a remote LAN firewall.

At step 420, data traffic destined for a WAN is selectively split between remote firewall inspection and local direct access, based on a type of service, as discussed further below with respect to FIG. 5. Some of the data traffic is destined to a remote LAN and will traverse the secure tunnel without continuing to the WAN from the remote firewall.

At step 430, a remote firewall applies policies to forwarded LAN traffic before forwarding to the WAN. These policies are implementation-specific.

FIG. 5 is a more detailed flow diagram illustrating the step of selectively splitting WAN traffic, according to an embodiment. At step 510, a split traffic mode is enabled in the network edge device. Enabling can be manual or automatically triggered, for example, by a timer or by API instructions received from other software processes. Accordingly, a default mode of the network edge device is configured to transmit WAN data traffic over a secure tunnel for traversing the remote firewall en route to the WAN. A selection of one or more types of service to be split from WAN data traffic headed to the secure tunnel for direct transmission over the WAN without traversing the remote firewall is received.

At step 520, responsive to enabling the split traffic mode, configuring a software-based switch to split layer-2 data traffic between a first and a second output. Accordingly, the first output can be an aggregation link communicatively coupled to the WAN over the secure tunnel. Link aggregation generally combines several individual input links (e.g., Wi-Fi or Ethernet links) into a single logical output link. The second output can be a layer 3 NAT communicatively coupled directly to the WAN.

At step 530, a session of data packets directed to the WAN from a client is received. A service type associated with the session is identified using techniques such as header inspection, parsing, and deep packet inspection. In some embodiments, a session table is updated for new sessions as a cache for subsequent data packets of the same session. A session can be explicitly closed or timed out after being idle for a set amount of time.

At step 540, responsive to the service type classification matching at least one of the one or more split service types, the secure tunnel for the session with the remote destination is bypassed by switching to the layer 3 NAT for direct transmission to the WAN, a step 550.

At step 560, responsive to the service type classification not matching at least one of the one or more split service types, default tunneling is continued by switching to the aggregation link for transmission to the WAN through the remote firewall.

### III. Computing Device for Extended Firewall Exclusion (FIG. 6)

FIG. 6 is a block diagram illustrating a computing device 600, for use in system 100 of FIG. 1 in using similarity search of vector embeddings in zero-day threat detection of downloaded files, according to one embodiment. The computing device 600 is a non-limiting example device for implementing each of the components of the system 100, including LAN extender 110, remote firewall 120 and user device 130. Additionally, the computing device 600 is merely an example implementation itself, since the system 100 can also be fully or partially implemented with laptop computers, tablet computers, smart cell phones, Internet access applications, and the like.

The computing device 600, of the present embodiment, includes a memory 610, a processor 620, a hard drive 630, and an I/O port 640. Each of the components is coupled for electronic communication via a bus 650. Communication can be digital and/ or analog, and use any suitable protocol.

The memory 610 further comprises network access applications 612 and an operating system 614. Network access applications can include 612 a web browser, a mobile access application, an access application that uses networking, a remote access application executing locally, a network protocol access application, a network management access application, a network routing access applications, or the like.

The operating system 614 can be one of the Microsoft Windows® family of operating systems (e.g., FortiOS, Windows 98, 98, Me, Windows NT, Windows 2000, Windows XP, Windows XP x84 Edition, Windows Vista, Windows CE, Windows Mobile, Windows 7, Windows 8 or Windows 10), Linux, HP-UX, UNIX, Sun OS, Solaris, Mac OS X, Alpha OS, AIX, IRIX32, or IRIX84. Microsoft Windows is a trademark of Microsoft Corporation.

The processor 620 can be a network processor (e.g., optimized for IEEE 802.11), a general-purpose processor, an access application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 620 can be single core, multiple core, or include more than one processing elements. The processor 620 can be disposed on silicon or any other suitable material. The processor 620 can receive and execute instructions and data stored in the memory 610 or the hard drive 630.

The storage device 630 can be any non-volatile type of storage such as a magnetic disc, EEPROM, Flash, or the like. The storage device 630 stores code and data for access applications.

The I/O port 640 further comprises a user interface 642 and a network interface 644. The user interface 642 can output to a display device and receive input from, for example, a keyboard. The network interface 644 connects to a medium such as Ethernet or Wi-Fi for data input and output. In one embodiment, the network interface 644 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C #, Oracle® Java, JavaScript, PHP, Python, Perl, Ruby, AJAX, and Adobe® Flash®. The computer software product may be an independent access point with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

The phrase network appliance generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, layer 2/3 routing, content inspection, content filtering, firewall, traffic shaping, application control, Voice over Internet Protocol (VoIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL and FORTIPHISH families of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTI Wi-Fi family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems) and FORTIEXTENDER.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical access applications. This description will enable others skilled in the art to best utilize and practice the invention in various embodiments and with various modifications as are suited to a particular use.

The scope of the invention is defined by the following claims.

We claim:

1. A computer-implemented method, in a local access network (LAN) extension device communicatively coupled to a LAN and to a wide-area network (WAN), for selectively splitting data traffic for exclusion from secure tunneling based on service type, the method comprising:
establishing a virtual extendable LAN (VXLAN) over a secure tunnel from the network edge device to a remote LAN firewall;
enabling a split traffic mode in the network edge device, wherein a default mode of the network edge device is configured to transmit WAN data traffic over a secure tunnel for traversing the remote firewall en route to the WAN, and receiving a selection of one or more types of service to be split from WAN data traffic headed to the secure tunnel for direct transmission over the WAN without traversing the remote firewall;
responsive to enabling the split traffic mode, configuring a software-based switch to split layer-2 data traffic between a first output communicatively coupled to the WAN over the secure tunnel and a second output communicatively coupled directly to the WAN;
receiving, at an input port, a session of data packets directed to the WAN from a client;
classifying a service type associated with the session;
responsive to the service type classification matching at least one of the one or more split service types, bypassing the secure tunnel for the session with the remote destination by switching to the second output for direct transmission to the WAN; and
responsive to the service type classification not matching at least one of the one or more split service types, continuing default mode by switching to the first output for transmission to the WAN through the remote firewall.

2. The method of claim 1, wherein the first output comprises an aggregation link communicatively coupled to the WAN over the secure tunnel.

3. The method of claim 1, wherein the second output comprises a layer 3 NAT communicatively coupled directly to the WAN.

4. The method of claim 1, wherein the layer 3 NAT addresses packets of the session using network address translation (NAT).

5. The method of claim 1, wherein the one or more service types comprises UDP, TCP, port number, IP address, FQDN name.

6. The method of claim 1, wherein the secure tunnel comprises a virtual private network (VPN) tunnel.

7. The method of claim 1, wherein the session corresponds to a voice application or a video application.

8. The method of claim 1, wherein the session corresponds to local traffic within the LAN.

9. The method of claim 1, wherein the split traffic is routed through an underlay of the first port rather than an overlay of the second port.

10. A non-transitory computer-readable medium storing source code, a local access network (LAN) extension device communicatively coupled to a LAN and to a wide-area network (WAN), at least partially implemented in hardware, that when executed by a processor, performs a method for selectively splitting data traffic for exclusion from secure tunneling based on service type, the method comprising:
establishing a virtual extendable LAN (VXLAN) over a secure tunnel from the network edge device to a remote LAN firewall;
enabling a split traffic mode in the network edge device, wherein a default mode of the network edge device is configured to transmit WAN data traffic over a secure tunnel for traversing the remote firewall en route to the WAN, and receiving a selection of one or more types of service to be split from WAN data traffic headed to the secure tunnel for direct transmission over the WAN without traversing the remote firewall;
responsive to enabling the split traffic mode, configuring a software-based switch to split layer-2 data traffic between an aggregation link communicatively coupled to the WAN over the secure tunnel and a layer 3 NAT communicatively coupled directly to the WAN;
receiving, at an input port, a session of data packets directed to the WAN from a client;
classifying a service type associated with the session;
responsive to the service type classification matching at least one of the one or more split service types, bypassing the secure tunnel for the session with the remote destination by switching to the layer 3 NAT for direct transmission to the WAN; and
responsive to the service type classification not matching at least one of the one or more split service types, continuing default mode by switching to the aggregation link for transmission to the WAN through the remote firewall.

11. A local access network (LAN) extension device communicatively coupled to a LAN and to a wide-area network (WAN), for selectively splitting data traffic for exclusion from secure tunneling based on service type, the LAN extension device comprising:
a processor;
a network interface communicatively coupled to the processor and to the WAN and to the LAN; and
a memory, communicatively coupled to the processor and storing:
a VXLAN module configured to establish a virtual extendable LAN (VXLAN) over a secure tunnel from the network edge device to a remote LAN firewall;
a software switch module configured to enable a split traffic mode in the network edge device, wherein a default mode of the network edge device is configured to transmit WAN data traffic over a secure tunnel for traversing the remote firewall en route to the WAN, and receiving a selection of one or more types of service to be split from WAN data traffic headed to the secure tunnel for direct transmission over the WAN without traversing the remote firewall;
wherein responsive to enabling the split traffic mode, the software switch module configures a software-based switch to split layer-2 data traffic between an aggregation link communicatively coupled to the WAN over the secure tunnel and a layer 2 switch communicatively coupled directly to the WAN;
a classifier to receive, at an input port, a session of data packets directed to the WAN from a client;
wherein the classifier identifies a service type associated with the session,
wherein the software switch module, responsive to the service type classification matching at least one of the one or more split service types, bypasses the secure tunnel for the session with the remote destination by switching to the layer-2 switch for direct transmission to the WAN, and
wherein the software switch module, responsive to the service type classification not matching at least one of the one or more split service types, continues default mode by switching to the aggregation link for transmission to the WAN through the remote firewall.
